(19) United States
(12) Patent Application Publication
(10) Pub. No.: US 2006/0170817 A1
(43) Pub. Date: Aug. 3, 2006

(54) Camera assembly structure

(75) Inventor: Chieh-Feng Wu, Taipei (TW)

Correspondence Address: G. LINK Co., LTD, 3550 Bell Road, MINOOKA, IL, 60447, US

(73) Assignee: BEHAVIOR TECH COMPUTER CORP.

(21) Appl. No.: 11/049,168

(22) Filed: Feb. 3, 2005

(51) Int. Cl. H04N 5/225

(52) U.S. Cl. 348/373

(57) ABSTRACT

The present invention is a camera assembly structure having a body and a base. The body, having a front cover, a back cover and a focus ring clamped between the front and back covers, is connected at the base and can rotate in relation to the base. The base has a front base, an elastic component, and a back base. The front base has two side troughs for inserting the elastic component, and the elastic component can move along the side troughs. The back base engaging with partial structure of the front cover is connected at the elastic component and can use the elastic component as an axis so as to rotate downward.

### FIELD OF THE INVENTION

The present invention is related to a web camera; particularly, it is related to a foldable web camera so as to reduce the overall size for carrying and storage, and for providing a clamping capability to clamp on an electronic device.

### BACKGROUND OF THE INVENTION

The holding means for holding the conventional web cams on an electronic device, such as a notebook, an LCD, and so on, is as follows: One means is to adapt the clamping force of a damper so as to clamp the web cam on the electronic device. Although the damper can be adjusted according to the thickness of the various electronic devices, a large clamping force can easily cause the electronic device to break. Furthermore, the main drawback of the damper is that for those electronic devices with a greater thickness, the length of the two clamping arms of the damper must be increased. Another means is to adapt a base in slight n-shape so as to utilize the fixed size of the opening of the base; the two opposite sidewalls of the opening press against the two sides of the electronic device respectively. The main drawback of the n-shape base is that because the size of the opening of the n-shape base is fixed, it is only useful for an electronic device having the same thickness as the size of the opening.

Due to the two conventional means being limited to the thickness of the electronic device and having a size too large to carry or store, the inventor of the present invention provides an improved assembly structure that is foldable and can be flexibly adjusted so that the web cam can be more easily utilized.

### SUMMARY OF THE INVENTION

The objective of the present invention is to provide an assembly structure that is foldable and can reduce the overall size so as to facilitate carrying and storing of a camera.

Another objective of the present invention is to provide an assembly structure that can easily adjust the holding position for a camera in accordance with various thicknesses of the electronic devices.

In order to accomplish the above objectives, the present invention provides a camera assembly structure having a body and a base. The body, having a front cover, a back cover and a focus ring clamped between the front and back covers, is connected at the base and can rotate in relation to the base. The base has a front base having at least two side troughs, an elastic component engaged with the front base and movable along the side troughs, and a back base capable of being engaged with the partial structure of the front base; the back base is connected at the elastic component and can use the elastic component as an axis so as to rotate downward.

### BRIEF DESCRIPTION OF THE DRAWINGS

The above objects and advantages of the present invention will become more apparent with reference to the appended drawings wherein:

FIG. 1 shows an elevational diagram of the camera assembly structure of the present invention;

FIG. 2 shows a rotating positional diagram of the body of the present invention;

FIG. 3 shows an exploded diagram of the camera assembly structure of the present invention;

FIG. 4 shows a side diagram of the camera assembly structure of the present invention;

FIG. 5 shows a moving positional diagram of the elastic component of the present invention; and

FIG. 6 shows a side diagram of the camera with the assembly structure of the present invention on the electronic device when in use.

### DETAILED DESCRIPTION OF THE INVENTION

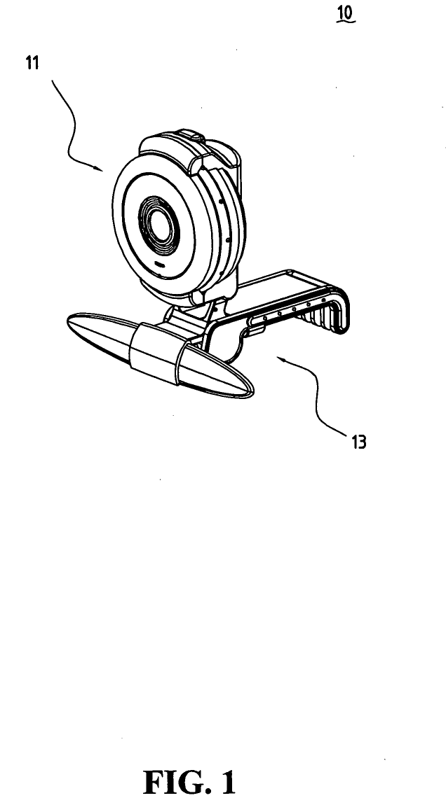

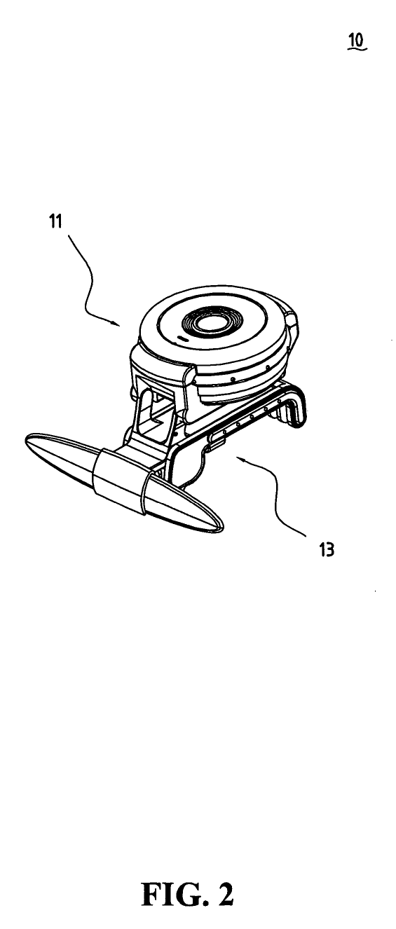

FIG. 1 shows an elevational diagram of the camera assembly structure of the present invention, while FIG. 2 shows a rotating positional diagram of the body of the present invention. The assembly structure 10 of the present invention is an assembly structure used for a camera. The camera can be a web cam, a digital cam, etc. The assembly structure 10 includes a body 11, and a base 13. The internal space of the body 11 can contain the optical module/circuit module 117 of the camera, and the body 11 is connected at the base 13 rotatable at any degree. When the body 11 rotates so as to be almost parallel to the base 13, the overall size of the assembly structure 10 can be significantly reduced to facilitate carrying and storage.

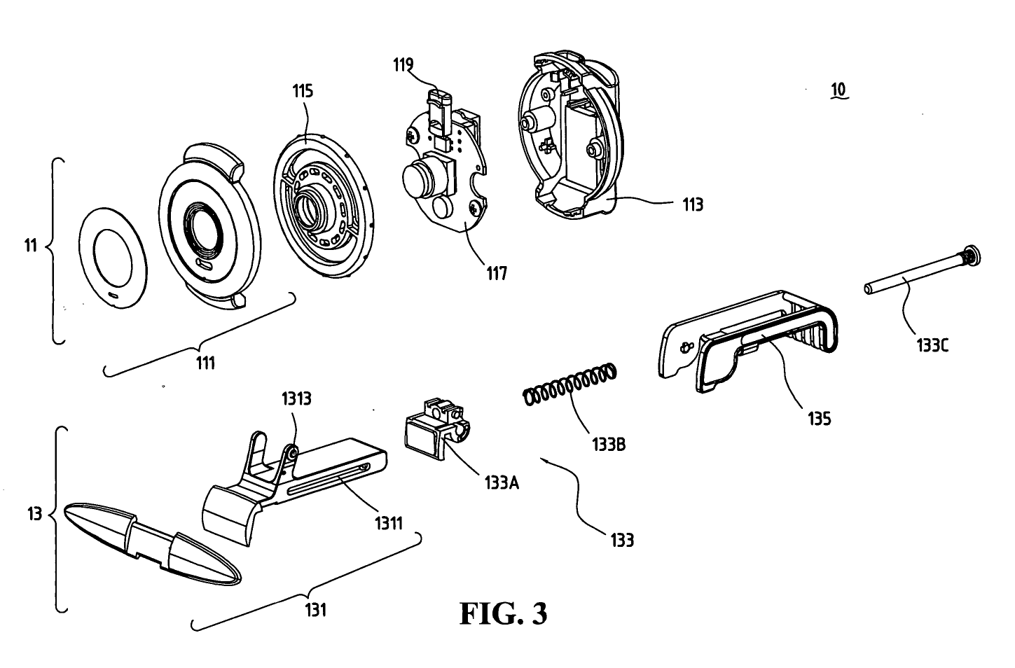

FIG. 3 shows an exploded diagram of the camera assembly structure of the present invention. The body 11 includes a front cover 111, a back cover 113, and a focus ring 115 clamped between the front cover 111 and the back cover 113. The shape of the body 11 in one embodiment can be slightly elliptical. When the body 11 is assembled, the focus ring 115 and optical module/circuit module 117 can be clamped between the front cover 111 and the back cover 113 respectively. Then connect the front cover 111 and the back cover 113. Finally, the body 11 is connected to the connecting pillar 1313 of the front base 131. Since the focus ring 115 of the present invention utilizes the rotation of the outer ring wall to achieve the focusing function. The area of the ring wall is suited for the rotating operation of the user's hand, and thus can easily operate the camera to focus.

The base 13 mainly includes a front base 131, an elastic component 133, and a back base 135. The shape of the front base 131 in one embodiment can be slightly T-shaped. The two sides of the front base 131 are two side troughs 1311 for engaging with the elastic component 133 respectively. The elastic component 133 can move along the side troughs 1311. An embodiment of the means of the elastic component 133 is by a moving block 133A, an elastic element 133B, and the tip of a nail 133C. The internal space of the front base 131 is used for containing and engaging with the elastic element 133B. At the same time, the opening of the two side troughs 1311 is provided for inserting the upper end of the moving block 133A so that the moving block 133A can move in parallel along the side troughs 1311. One end of the elastic element 133B is pressed against the moving block 133A, and the other end is pressed against the back end of the back base 135, while the tip of the nail 133C passes through the elastic element 133B. The present invention can use a spring as an embodiment of the elastic element 133B.

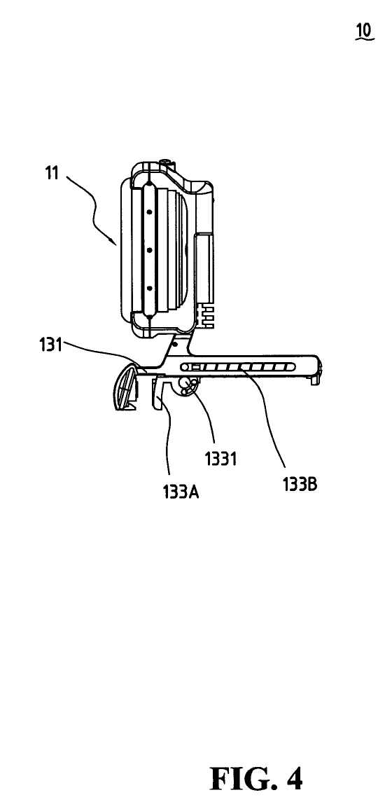

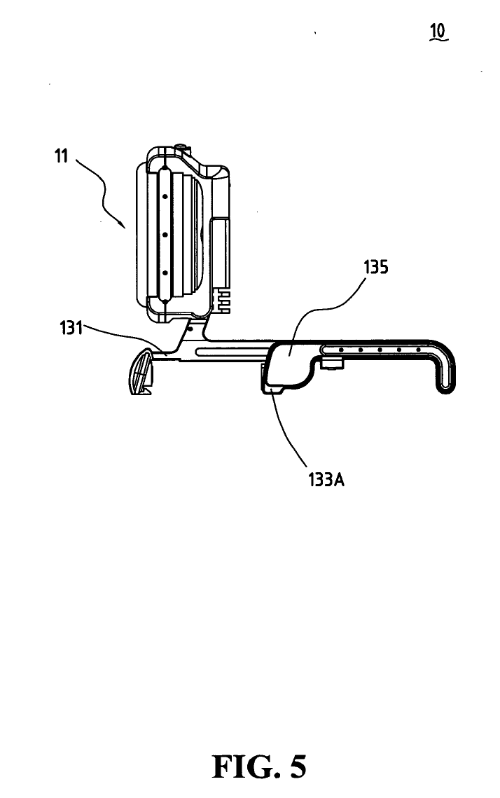

Refer to FIG. 4. The moving block 133A can stably press against the side of the electronic device through the elasticity provided by the elastic element 133B. Refer to FIG. 5, the back base 135 is engaged with partial structure of the front base 131, and allow the engaged portion of the front base 131 to move at the location. The back base 135 is connected to the moving block 133A so that the back base 135 is movable with the moving block 133A.

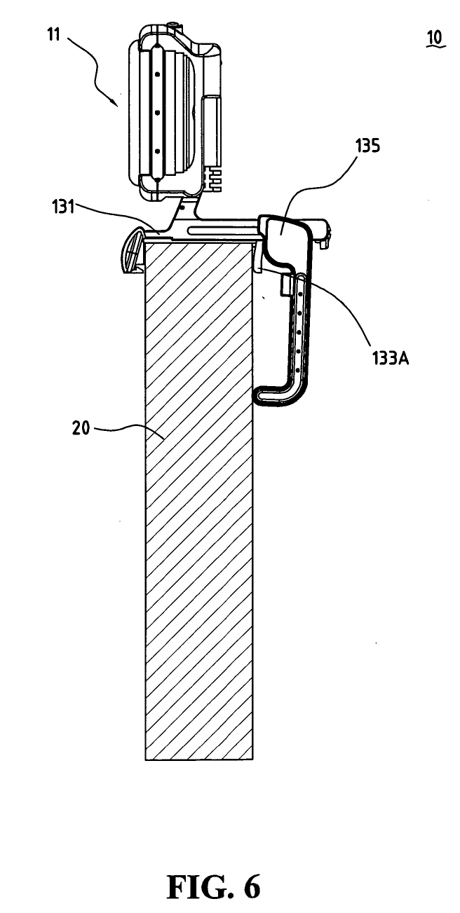

FIG. 6 shows a side diagram of the camera with the assembly structure of the present invention on the electronic device when in use. The two connecting holes 1331 set by the moving block 133A as shown in FIG. 4 are for connecting to the back base 135. The back base 135 uses the connecting holes 1331 as an axis to rotate downward. The back base 135 of the assembly structure can rotate to a position vertical to the front base 131. Then, the assembly structure 10 respectively crosses and presses against the two sides of the electronic device 20. The electronic device 20 can be a notebook or an LCD, etc. Since the moving block 133A can move its location, and the back base 135 can move along with it, the assembly structure 10 can be adapted to electronic devices 20 with any thickness. In addition, since the elasticity provided by the elastic element 133B allows the moving block 133A to stably press against one side of the electronic device 20, the assembly structure 10 can hold onto the two sides of the electronic device 20.

The focus ring 115 of the present invention is located between the front cover 111 and the back cover 113. This is different from the conventional camera or digital camera which locates the focus ring at the front. The size of the focus ring 115 of the present invention is close to (or even larger than) the front cover 111, and thus the operability can be easily obtained. Furthermore, the material of the focus ring 115 can be a material pervious to light; particularly, the material of the outer ring can be a material pervious to light so as to allow the light source inside the focus ring 115 to pass through.

In addition, the body 11 of the present invention further includes a button 117 used for capturing the image by the camera. The material of the button 117 can be a material pervious to light so as to allow the light source inside the button 117 to pass through.

Those skilled in the art are to note that the present invention can be modified without leaving the scope and spirit of the present invention. The scope of the present invention is covered by the appended claims and all the substantial equivalents of variation and arrangement.

What is claimed is:

1. A camera assembly structure, comprising:
a body having a front cover, a back cover, and a focus ring clamped between said front and back covers, wherein said body is connected to a base and can rotate in relation to said base; said base comprising:
a front base having at least two side troughs;
an elastic component engaged in said front base and movable along said side trough; and
a back base capable of being engaged in partial structure of said front base structure, connected to said elastic component and can use said elastic component as an axis so as to rotate downwards.

2. The camera assembly structure of claim 1, wherein said elastic component comprises:
an elastic element engaged in said front base;
a moving block partially placed in said two side troughs respectively, and said moving block movable along said side trough; and
a nail passing through said elastic element.

3. The camera assembly structure of claim 2, wherein said back base is connected to said moving block and can use said moving block as an axis so as to move downward.

4. The camera assembly structure of claim 1, wherein said body is slightly in flat circular shape.

5. The camera assembly structure of claim 1, wherein said front base is slightly in T shape.

6. The camera assembly structure of claim 1, wherein one end of said elastic element stops said moving block and the other end stops the back of said front base.

7. The camera assembly structure of claim 1, wherein said elastic element is a spring.

8. The camera assembly structure of claim 1, wherein said front base is a connecting pillar so as to connect said body.

9. The camera assembly structure of claim 1, wherein said moving block has two connecting holes connected to said back base respectively.

10. The camera assembly structure of claim 1, wherein said body further comprises a button.

11. The camera assembly structure of claim 10, wherein said button is made of a material pervious to light.

12. The camera assembly structure of claim 1, wherein said focus ring is made of a material pervious to light.
